(19) United States
(12) Patent Application Publication
(10) Pub. No.: US 2002/0103278 A1
(43) Pub. Date: Aug. 1, 2002

(54) Waterborne coating composition

(76) Inventors: John M. Krajnik, Shaker Heights, OH (US); Victor H. Lam, Broadview Heights, OH (US); Lynn O. Sabo, Strongsville, OH (US); James M. Camerson, Brunswick, OH (US); Martin L. Mittleman, Lyndhurst, OH (US); Kuyler M. Wise, Bay Village, OH (US)

Correspondence Address: Vivien Y. Tsang, Esq., The Sherwin-Williams Company, 1100 Midland Bldg. - Legal Dept., 101 Prospect Avenue, N.W., Cleveland, OH, 44115-1075, US

(21) Appl. No.: 09/952,390

(22) Filed: Sep. 14, 2001

Related U.S. Application Data
(60) Provisional application No. 60/232,699, filed on Sep. 15, 2000.

(51) Int. Cl. C08J 3/00

(52) U.S. Cl. 524/192; 524/515

(57) ABSTRACT

A waterborne coating composition for a cured film having improved film properties and uniform film formation comprising a binder polymer containing a reactive keto group, at least one carboxylic monohydrazide or dihydrazide or polyhydrazide compound, and a reaction moderator. More specifically, the waterborne coating composition comprises (a) at least one binder polymer comprising at least one or more copolymerizable monoethylenically unsaturated monomers, wherein at least one of the monoethylenically unsaturated monomers contains at least one reactive keto group; and (b) at least one monohydrazide or dihydrazide or polyhydrazide compound; and (c) at least one reaction moderator. Reaction moderators moderate or retard the crosslinking process before film formation occurs and then act to catalyze the film formation crosslinking reaction. The final cured film product of the waterborne coatings produced by this invention have a much higher crosslink density per unit time and a uniform film formation.

### CROSS-REFERENCE TO RELATED APPLICATION

This application claims the benefit of U.S. Provisional Application No. 60/232699, filed Sep. 15, 2000.

### BACKGROUND OF THE INVENTION

This invention relates to a waterborne coating for a cured film having improved film properties and uniform film formation, and a method for producing the coating. The waterborne coatings of this invention utilize reaction moderators that moderate or retard the crosslinking process before film formation occurs and then act to catalyze the film formation crosslinking reaction. The final cured film product of the waterborne coatings produced by this invention have a much higher crosslink density per unit time and a uniform film formation. The present invention also relates to a process for forming a highly crosslinked cured film having uniform film formation, wherein the cured film is cured by allowing it to be catalyzed by a reaction moderator.

Waterborne coating compositions as used herein are coatings in which the principal application medium is a mixture of water and an essentially nonvolatile organic material capable of interacting with a base film forming polymer and/or crosslinking agent. Waterborne coatings have problems peculiar to systems containing a mixture of water and organic co-solvent or dispersant. These problems arise from the fact that the evaporation of water is dependent upon ambient conditions. In the case of waterborne coatings, it is imperative that during the drying stage, a uniform layer of coating be maintained until the water and organic co-solvents have evaporated, leaving a uniform film of insoluble organic polymer. Under ambient conditions, however, imperfections on the surface of the cured film can develop during film formation which are detrimental to the overall performance of the coating. These imperfections may be related to the crosslinking reactions taking place in the aqueous phase during film formation. For improving problems relating to these imperfections, it has been found by this invention that reaction moderators may be added to the coating composition to “moderate” the crosslinking reaction during the film formation. The addition of at least one reaction moderator imparts an improved and more uniform film having improved physical properties. Also, it has been found that the reaction moderators can catalyze the film formation crosslinking reaction, thereby producing a cured film having much increased crosslink density.

It is an object of this invention to provide a waterborne coating for a cured film having improved film properties and uniform film formation, by utilizing a coating composition comprising a binder polymer containing a reactive keto group, at least one carboxylic monohydrazide, dihydrazide or polyhydrazide compound, and at least one reaction moderator. The reaction moderators act to moderate or retard the crosslinking reaction prior to film formation, and which, after evaporation of the aqueous phase, would then catalyze the film formation crosslinking reaction in the co-solvent organic phase. The resulting cured film produced by the waterborne coating composition of this invention has superior crosslink density, and a smooth and uniform coating surface. The waterborne coating composition may also comprise a dispersant and/or a thickener having post-film formation crosslinking groups. The crosslinking groups present in the polymer of the dispersant and/or the thickener can be adjusted, depending on the particular binder resin used, to optimize the desired performance properties of the coating composition. Specifically, a coating composition can be tailor made to have increased chemical resistance, corrosion resistance, stability, humidity, hardness, and/or adhesion to a particular substrate by altering the levels of crosslinking on the binder, thickener and dispersant.

### SUMMARY OF THE INVENTION

The present invention is directed to a waterborne coating composition for a cured film having improved film properties and uniform film formation comprising a binder polymer containing a reactive keto group, at least one carboxylic monohydrazide or dihydrazide or polyhydrazide compound, and a reaction moderator. More specifically, the waterborne coating composition comprises (a) at least one binder polymer comprising at least one or more copolymerizable monoethylenically unsaturated monomers, wherein at least one of the monoethylenically unsaturated monomers contains at least one reactive keto group; and (b) at least one monohydrazide or dihydrazide or polyhydrazide compound; and (c) at least one reaction moderator. The coating composition can also comprise other polymers containing a reactive keto group. Examples of other polymers may be latexes, thickeners, dispersant, and others.

### BRIEF DESCRIPTION OF THE DRAWINGS

FIG. 1 illustrates viscosity vs. time of the gelation of uncatalyzed resin and resin catalyzed with HEXCEM and DESMORAPID PP.

FIG. 2 illustrates crosslink density versus fraction of free volume of uncatalyzed resin and catalyzed resin.

FIG. 3 illustrates reaction moderator DESMORAPID PP facilitating uniform film formation in a non-pigmented film made according to this invention.

FIG. 4 illustrates the same film as FIG. 3 made without the use of a reaction moderator.

### DETAILED DESCRIPTION OF THE DRAWINGS

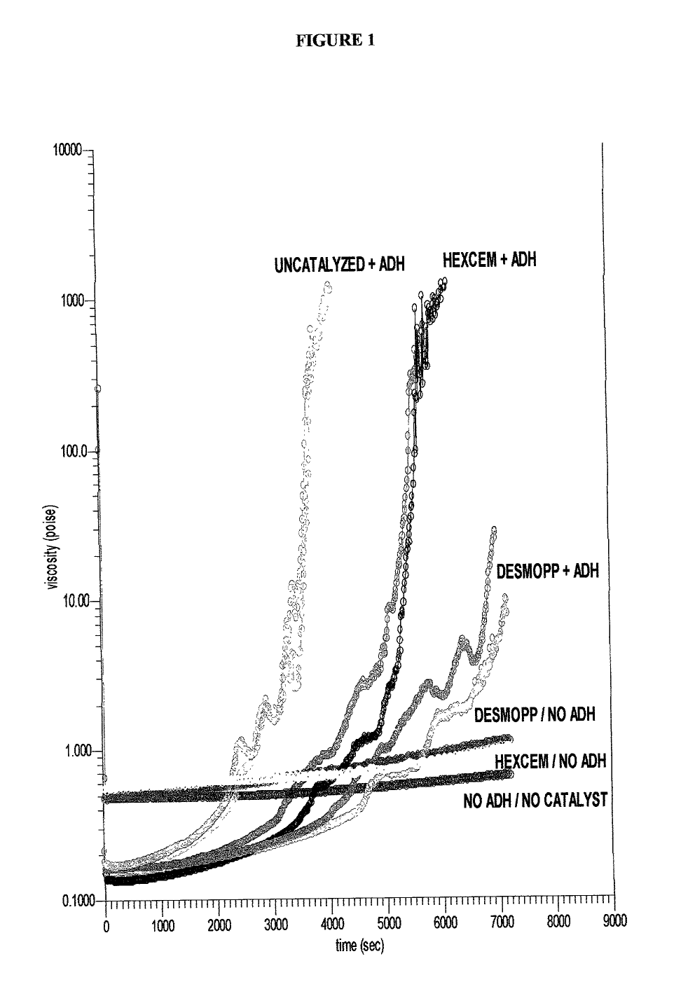

FIG. 1. A sample set 1 was prepared by mixing a polymer containing 35% diacetone acrylamide (DAAM) with adipic dihydrazide (ADH) to get a 1:1 DAAM:ADH weight ratio. A sample set 2 was prepared from the same polymer but no ADH was added. Each of these two sets was then split into three portions. Desmorapid PP (commercially available from Bayer Corporation, Pittsburgh, Pa.) and HexCem LFD (commercially available from OMG, Cleveland, Ohio) were added to each portion at 2% resin solids and 2000 ppm metal/resin solids, respectively. The rate of gelation for all six samples was then measured on a TA Instruments AR500 Rheometer. Parallel plates (4 cm diameter) were used to measure the viscosity. The temperature was set at 45° C. and the stress was set at a constant 25 dynes/cm². The measurements were run over two hours. As can be seen by FIG. 1, the addition of the catalysts retards the viscosity build. The samples without adipic dihydrazide show no significant viscosity build during the duration of this measurement.

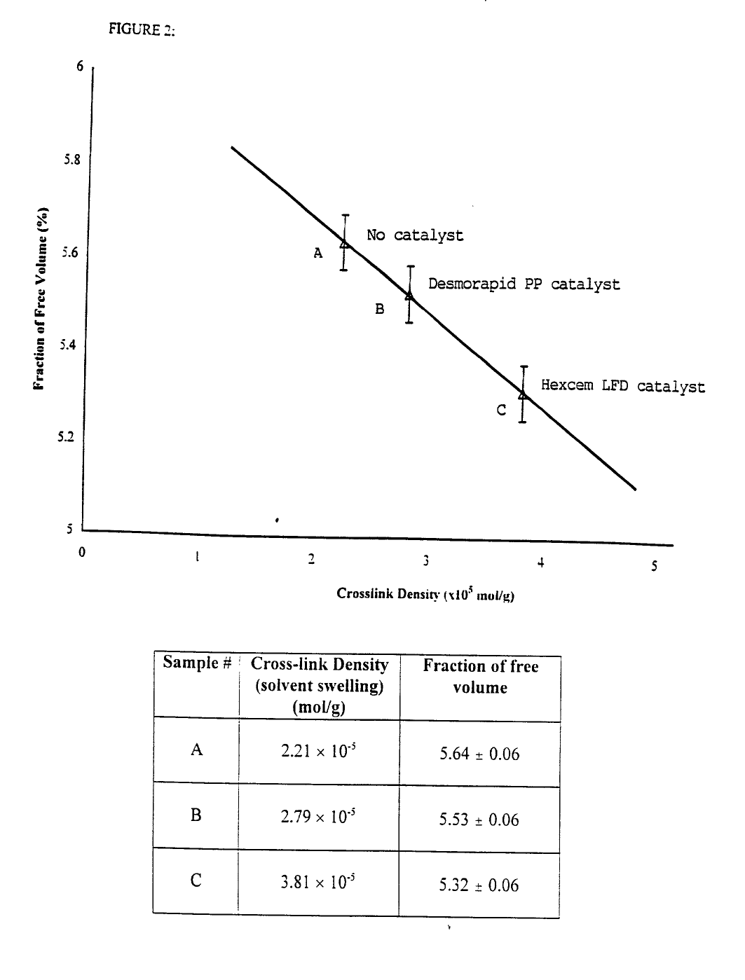

FIG. 2 illustrates results of a measurement by positron annihilation spectroscopy of crosslink density versus fraction of free volume of uncatalyzed resin and resin catalyzed with Desmorapid PP and HEXCEM LFD catalyst.

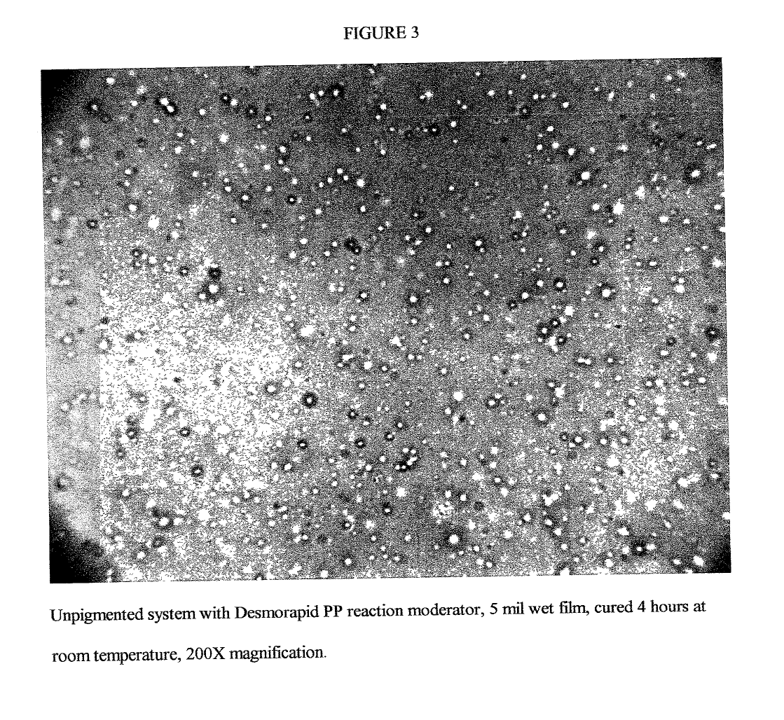

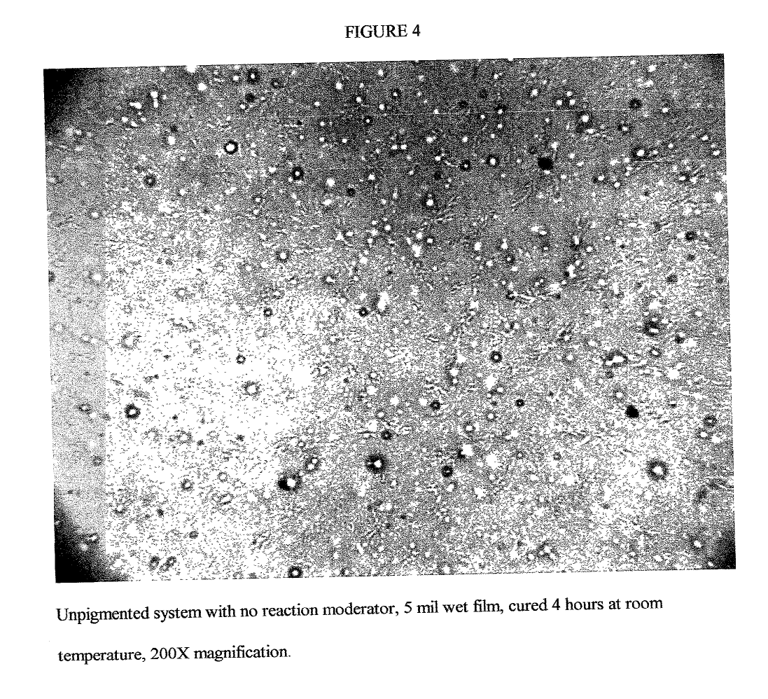

FIGS. 3 and 4 show 200× magnification visual differences in dried films of non-pigmented uncatalyzed film vs. film catalyzed with Desmorapid PP. The films were cast at 5 mils wet thickness, and cured for four hours at room temperature. The uncatalyzed film shows formation of branching and filamentary defects. The film that was catalyzed by Desmorapid PP and displays some of this invention's advantageous results of the absence of branching and filamentary defects.

### DETAILED DESCRIPTION OF THE INVENTION

According to this invention, the overall film formation is the reaction product of at least one binder polymer containing a reactive keto group, and at least one monohydrazide or dihydrazide or polyhydrazide compound a carboxylic dihydrazide, and a reaction moderator. In waterborne coatings, film formation can result only from the removal of water through evaporation. The quality of the final coating of this invention is dependent on the crosslinking reactions, which are being retarded through the use of reaction moderators, during the water evaporation prior to film formation.

### Binder

The latex polymers in accordance with the present invention (also referred to herein as “binders”) include those polymers polymerized from one or more suitable monomers, wherein the binder contains at least one reactive keto group. Typically, the binders are polymerized from one or more copolymerizable monoethylenically unsaturated monomers such as, for example, vinyl monomers and acrylic monomers, with at least one other vinyl or acrylic monomer containing a keto group.

The vinyl monomers suitable for use in accordance with the present invention include any compounds having vinyl functionality, i.e., ethylenic unsaturation, exclusive of compounds having acrylic functionality, e.g., acrylic acid, methacrylic acid, esters of such acids, acrylonitrile and acrylamides. Preferably, the vinyl monomers are selected from the group consisting of vinyl esters, vinyl aromatic hydrocarbons, vinyl aliphatic hydrocarbons, vinyl alkyl ethers and mixtures thereof.

Suitable vinyl monomers include vinyl esters, such as, for example, vinyl propionate, vinyl laurate, vinyl pivalate, vinyl nonanoate, vinyl decanoate, vinyl neodecanoate, vinyl butyrates, vinyl benzoates, vinyl isopropyl acetates and similar vinyl esters; vinyl aromatic hydrocarbons, such as, for example, styrene, methyl styrenes and similar lower alkyl styrenes, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3-butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

The acrylic monomers suitable for use in accordance with the present invention comprise any compounds having acrylic functionality. Preferred acrylic monomers are selected from the group consisting of alkyl acrylates, alkyl methacrylates, acrylate acids and methacrylate acids as well as aromatic derivatives of acrylic and methacrylic acid, acrylamides and acrylonitrile. Typically, the alkyl acrylate and methacrylic monomers (also referred to herein as “alkyl esters of acrylic or methacrylic acid”) will have an alkyl ester portion containing from 1 to about 12 carbon atoms per molecule, preferably about 1 to 5 carbon atoms per molecule. Suitable acrylic monomers include, for example, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, benzyl acrylate and methacrylate, isobornyl acrylate and methacrylate, neopentyl acrylate and methacrylate, 1-adamantyl methacrylate and various reaction products such as butyl, phenyl, and cresyl glycidyl ethers reacted with acrylic and methacrylic acids, hydroxyl alkyl acrylates and methacrylates such as hydroxyethyl and hydroxypropyl acrylates and methacrylates, amino acrylates, methacrylates as well as acrylic acids such as acrylic and methacrylic acid, ethacrylic acid, alpha-chloroacrylic acid, alpha-cyanoacrylic acid, crotonic acid, beta-acryloxy propionic acid, and beta-styryl acrylic acid. In addition to the specific monomers described above, those skilled in the art will recognize that other monomers such as, for example, allylic monomers, or monomers which impart wet adhesion, e.g., methacrylamidoethyl ethylene urea, can be used in place of, or in addition to, the specifically described monomers in the preparation of the binders (as well as the dispersants and thickeners hereinafter described). Further details concerning such other monomers suitable for copolymerization in accordance with the present invention are known to those skilled in the art. The amount of such other monomers is dependent on the particular monomers and their intended function, which amount can be determined by those skilled in the art.

The binder polymer of the present invention has at least one keto group for crosslinking functionality. Examples of monomers having at least one keto group are acrolein, methacrolein, diacetone acrylamide, diacetone methacrylamide and vinylaceto acetate. The binder resin of the present invention contains about 0.1 to 50% weight percent of at least one monomer having at least one reactive keto group. These monomers result in postcrosslinking, for example, when the aqueous polymer emulsion simultaneously contains an appropriate added amount of a monohydrazide, dihydrazide or polyhydrazide compound. The monohydrazide or dihydrazide or polyhydrazide compounds suitable for this invention has one or more hydrazino groups (—NH—NH2) per molecule which bind directly to the carbon atoms of the keto group. Examples of these are maleic dihydrazide, fumaric dihydrazide, itaconic dihydrazide, phthalic dihydrazide, isophthalic dihydrazide, terephthalic dihydrazide, oxalic dihydrazide, adipic dihydrazide and sebacic dihydrazide, and others. The monohydrazide dihydazide, or polyhydrazide compound preferably has between 1 to 10 carbon atoms with an amount from 0.1 to 3 molar equivalent based on the keto group content in the binder polymer, permitting the coating composition to crosslink to form the highly crosslinked cured film. The monohydrazide or dihydrazide or polyhydrazide compounds can be present in an amount between about 0.1 weight percent to about 3.0 weight percent, based on the total weight of the coating composition. More preferably, the monohydrazide or dihydrazide or polyhydrazide is present in an amount between about 0.5 weight percent to about 2.0 weight percent, based on the total weight of the coating composition. Typically, the particle size of the binders is from about 0.1 to 1.0 microns, preferably from about 0.2 to 0.4 microns and more preferably from about 0.25 to 0.3 microns. Monohydrazide and dihydrazide compounds can also be used for endcapping.

Typically, the viscosity of the binders of the present invention is from about 20 to 3000 and preferably from about 50 to 1500 centipoise (“cP”) measured with a 40 to 60 weight percent solids composition using a Brookfield Viscometer with a number 2 spindle at 60 revolutions per minute. The molecular weight of the binders of the present invention is typically from about 10⁴ to 10⁷, preferably from about 200,000 to 1,000,000 grams per gram mole. As used herein, the term “molecular weight” means weight average molecular weight. Techniques for altering molecular weight are well known and include, for example, utilizing multi-functional monomers and chain transfer agents. Techniques for measuring the weight average molecular weight of latex polymers are known to those skilled in the art. One such technique is, for example, gel permeation chromatography.

In one aspect of the present invention, the binder polymer comprises an acid functional latex. Specific acid functional monomers suitable for use in accordance with the present invention include, for example, acrylic acid, methacrylic acid, and maleic acid. A preferred vinyl acrylate binder resin comprises 0-60% by weight of a fatty acid vinyl ester, 0-50% by weight of methylmethacrylate, 0.1 to 50% by weight of diacetone acrylamide and 0-5% by weight methacrylic acid, based on the total weight of the polymer. The binder polymer can be present in an amount between about 20 weight percent to about 90 weight percent, based on the total weight of the coating composition, and preferably, between about 40 weight percent to about 80 weight percent, based on the total weight of the coating composition. Preferred monomers for an acrylic binder resin can include butyl acrylate, methyl methacrylate, diacetone acrylamide, methacrylic acid, and acrylonitrile. Diacetone acrylamide is preferably from 0.1-50% by weight based on the total weight of the polymer, depending on the particular application.

### Dispersants

A dispersant can also be used in accordance with the present invention. A suitable dispersant would comprise the reaction product of an unsaturated carboxylic acid monomer, a monoethylenically unsaturated monomer different from the carboxylic acid monomer, and a monomer having at least one keto group. The dispersant can also comprise a macromonomer comprising a hydrophobic portion and an alkyoxylated portion which is polymerizable with the other monomers.

Unsaturated carboxylic acid monomers are typically α,β-monoethylenically unsaturated carboxylic acids. Preferred carboxylic acid monomers are selected from the group consisting of acrylic acid, methacrylic acid, crotonic acid, itaconic acid, maleic acid, and mixtures thereof. The concentration of the carboxylic acid monomer can be from about 20 to 70 weight percent, preferably from about 20 to 50 weight percent and more preferably from about 35 to 45 weight percent based on the total weight of the polymer.

The monoethylenically unsaturated monomer different from the carboxylic acid monomer are typically alkyl substituted, such as alkyl acrylates or phenols, such as nonyl phenol. Typically, the amount of the monoethylenically unsaturated monomer different from carboxylic acid can be from about 5 to 70 weight percent, preferably from about 10 to 50 weight percent based on the total weight of the polymer.

Macromonomers that can be suitable for producing the dispersant polymer in accordance with the present invention can comprise a hydrophobic portion and an alkoxylated portion that is polymerizable with other monomer(s). As used herein, the term “macromonomer” means a polymerizable monomer that comprises the reaction product of two or more compounds. Such macromonomers include, for example, any alkoxylated, e.g., ethoxylated or propoxylated, monomers having ethylenic unsaturation and that are terminated by a hydrophobic fatty chain. Examples of unsaturated, polymerizable moieties include those selected from the group consisting of vinyl group containing moieties, methacryloyl, maleoyl, itaconoyl, crotonyl, an unsaturated urethane moiety, hemiester maleoyl, hemiester itaconoyl, CH₂═CHCH₂—O—, methacrylamido and substituted methacrylamido. Examples of hydrophobic moieties include those selected from the group consisting of alkyl, alkaryl (i.e., alkylaryl or aralkyl), aryl, linear, branched, saturated, and unsaturated, and having at least 6 carbon atoms, preferably from about 6 to about 30 carbon atoms per molecule.

Preferred macromonomers are urethane monomers that comprise the reaction product of a monohydric surfactant and a monoethylenically unsaturated isocyanate. Preferably, the urethane monomer is a nonionic urethane monomer that is the urethane reaction product of a monohydric nonionic surfactant with a monoethylenically unsaturated monoisocyanate, preferably one lacking ester groups, e.g., alpha, alpha-dimethyl-m-isopropenyl benzyl isocyanate. The monohydric nonionic surfactants are themselves well known and are usually alkoxylated, e.g., ethoxylated, hydrophobes containing adducted ethylene oxide to provide the hydrophilic portion of the molecule. The hydrophobes are usually aliphatic alcohols or alkyl phenols in which a carbon chain containing at least 6 carbon atoms, preferably about 6 to about 30 carbon atoms, provides the hydrophobic portion of the surfactant. These surfactants are illustrated by ethylene oxide adducts of dodecyl alcohol or octyl or nonyl phenol which are available in commerce and which contain about 5 to about 150, preferably 25 to about 60 moles of ethylene oxide per mole of hydrophobe. Other hydrophobic substituents, such as complex hydrophobes, disclosed for example in U.S. Pat. No. 5,488,180 issued Jan. 30, 1996, are suitable for use in accordance with the present invention.

The monoethylenically unsaturated isocyanates suitable for use in preparing the urethane monomers can be any isocyanates effective to form the desired urethane linkage. Preferably, the isocyanate is a monoethylenically unsaturated monoisocyanate. Any copolymerizable unsaturation may be employed, such as acrylate and methacrylate unsaturation. One may also use allylic unsaturation, as provided by allyl alcohol. These, preferably in the form of a hydroxy-functional derivative, as is obtained by reacting a C2-C4 monoepoxide, like ethylene oxide, propylene oxide or butylene oxide, with acrylic or methacrylic acid to form an hydroxy ester, are preferably reacted in equimolar proportions with an organic diisocyanate, such as toluene diisocyanate or isophorone diisocyanate. The preferred monoethylenic monoisocyanate is styryl, as in alpha, alpha-dimethyl-m-isopropenyl benzyl isocyanate, and this unsaturated monoisocyanate lacks the ester group so it forms urethanes which lack this group. The amount of the monoethylenically unsaturated isocyanate relative to the monohydric surfactant used in making the macromonomer, (on a mole ratio basis) is preferably from about 0.1-2.0 to 1, more preferably about 1.0 to 1.0.

Suitable macromonomers useful in this invention can also be represented by the formula:

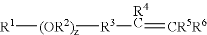

wherein:

R¹ is a monovalent residue of a substituted or unsubstituted hydrophobe compound;

each R² is the same or different and is a substituted or unsubstituted divalent hydrocarbon residue;

R³ is a substituted or unsubstituted divalent hydrocarbon residue;

R⁴, R⁵, R⁶ are the same or different and are hydrogen or a substituted or unsubstituted monovalent hydrocarbon residue;

and z is a value of 0 to 150.

Illustrative R³ substituents include, for example, simple or complex hydrophobe containing from 1 to 30 carbon atoms such as alkyl, aryl, aralkyl, alkaryl and cycloakyl groups.

Illustrative R³ substituents include, for example, the organic residue of ethers, esters, urethanes, amides, ureas, anhydrides and the like including mixtures thereof. The R³ substituent can be generally described as a “linkage” between the hydrophobe bearing surfactant or alcohol and the unsaturated portion of the macromonomer compound.

The oxyalkylene moieties included in the macromonomer compounds may be homopolymers or block or random copolymers of straight or branched alkylene oxides. Mixtures of alkylene oxides such as ethylene oxide and propylene oxides may also be employed.

Further details concerning the preparation of such macromonomers are known to those skilled in the art and are disclosed, for example, in U.S. Pat. Nos. 4,514,552, 4,801,671, 5,292,828, 5,292,843 and 5,294,693, incorporated herein by reference.

The amount of the macromonomer can be from about 0.5 to about 60 weight percent, more preferably from about 5 to about 50 weight percent, more preferably from about 35 to about 45 weight percent, still more preferably about 40 weight percent, based on the total weight of the dispersant polymer. Typically, the molecular weight of the macromonomer ranges from about 400 to 8000 grams per gram mole.

Typically the viscosity of the dispersants is from about 5 to 1500 cP in the un-neutralized form measured at 20° C. with a 20 to 50 weight percent solids composition using a Brookfield Viscometer with a number 2 spindle at 60 revolutions per minute. The molecular weight of the dispersants can be from about 10³ to 10⁶, preferably from about 5,000 to 10,000 grams per gram mole. Dispersants can be solution polymers or emulsions. For emulsions, the particle size of the dispersant can be from about 0.05 to 1.0 microns, preferably from about 0.1 to 0.4 microns and more preferably from about 0.1 to 0.3 microns. The dispersant can be present in an amount between about 0.1 weight percent to about 0.5 weight percent, based on the total weight of the coating composition. Preferably, the dispersant is present at about 0.15 weight percent to about 0.4 weight percent, based on the total weight of the coating composition.

### Thickeners

Any suitable thickeners may be optionally utilized in accordance with the present invention. Such thickeners are disclosed, for example, in U.S. Pat. Nos. 4,514,552, 4,722,962, 5,292,828 and 5,292,843, which are incorporated herein by reference. The thickeners typically comprise the aqueous emulsion reaction product of an unsaturated carboxylic acid monomer, e.g., methacrylic acid; a monoethylenically unsaturated monomer different from the carboxylic acid monomer, e.g. ethyl acrylate. The thickeners can also comprise a macromonomer comprising a hydrophobic portion and an alkoxylated portion which is polymerizable with the other monomers; and a monomer having at least one reactive keto functionality. The unsaturated carboxylic acid monomer, monoethylenically unsaturated monomer different from the carboxylic acid monomer, and monomer having at least one reactive keto-containing monomer used to polymerize the thickener can include those such as described above with reference to the binder polymer and dispersant. Often, the macromonomer is a urethane monomer which is the urethane reaction product of a monohydric surfactant and a monoethylenically unsaturated monoisocyanate. Typically, the monohydric surfactant comprises an ethoxylated or propoxylated aliphatic alcohol or alkyl phenol.

The thickeners are prepared using monomers such as those described above with respect to the preferred dispersants. Typically, the amount of the macromonomer can be from about 1 to 20 weight percent, preferably from about 5 to 15 weight percent based on the total weight of the polymer. Typically, the viscosity of the thickeners of the present invention is from about 5 to 1500 cP in the un-neutralized form measured at 20° C. with a 20 to 50 weight percent solids composition using a Brookfield Viscometer with a number 2 spindle at 60 revolutions per minute. The molecular weight of the thickeners of the present invention is typically from about 104 to 107, preferably from about 20,000 to 200,000 grams per gram mole. Typically, the particle size of the thickeners is from about 0.05 to 1.0 microns, preferably from about 0.1 to 0.4 microns and more preferably from about 0.1 to 0.3 microns. The thickener may optionally be present in an amount between 0-1 weight %, based on the total weight of the coating composition.

### Reaction Moderators

The term “reaction moderator(s)” as used herein is meant to indicate that in some manner, the compound(s) allow(s) for moderating or retarding the crosslinking process that occurs in the aqueous phase prior to film formation, thus forming a more uniform film during the water evaporation. The reaction moderator can also act as a catalyst to “catalyze” the post film formation crosslinking reaction after the water has evaporated, thus forming a highly crosslinked coating. While the inventors do not wish to be bound by the theoretical basis for the good results achievable with the use of the present invention, it is believed that the reaction moderators inhibit reaction in the wet coating by forming complexes with the reactants. As the coating dries thoroughly, the catalytic activities of the metals and/or amines are manifested to produce higher crosslink densities. The net result is a more controlled crosslinking reaction and a coating having higher crosslink density and more uniform film formation, and thus, better overall coating performance. Reaction moderators can be typical amine catalysts and metal catalysts, or catalysts which typically promote urethane reactions such as tertiary amines (such as bis(dimethylaminoethyl) ether and the like), organometallic salts of tin, zirconium, zinc, bismuth, (such as dibutyl tin diacetate, zinc octoate, and bismuth octoate). The following table lists some commercially available catalysts that may be used, either alone or in combination, as reaction moderators, and their commercial producer.

TABLE 1

| | | |
|---|---|---|
| NAME | SUPPLIER | DESCRIPTION |

Amine catalysts

| | | |
|---|---|---|
| 1,1,3,3-tetramethyl | Aldrich | |
| guanidine | | |
| Accelerator 399 | Huntsman | Triethanol amine |
| Ammonium Acetate | Aldrich | ammonium acetate |
| Benzyl trimethyl | Aldrich | 40% in methanol |
| ammonium | | |
| hydroxide | | |
| BYK 470 | BYK Chemie | an amine salt of dodecylbenzene |
| | | sulfonic acid |
| CGCL 287 | Ciba | Polymeric amine salt |
| Dabco Crystalline | Air Products | amine catalyst |
| Desmorapid PP | Bayer | amine catalyst |
| DRI-Rx HF | OMG | 30% active solution of |
| | | 2,2″bipyridyl in glycol ethers |
| Tetrabutyl | Aldrich | |
| ammonium | | |
| fluoride | | |
| Triethanol | N/A | Mixture of triethanol amine and |
| Ammonium | | acetic acid |
| Acetate | | |

Metal catalysts

| | | |
|---|---|---|
| 12% Iron Neo-Nap | OMG | 12.0% Iron |
| 2% Lithium | OMG | lithium salt of neodecanoic acid |
| Ten-Cem | | in aqueous solution |
| 22% Zinc | OMG | 22% zinc |
| Hex-Cem | | |
| 5% Calcium | OMG | 5% calcium |
| Hydro-Cem | | |
| 6% Manganese | OMG | Manganese salf of 2-ethylhexanoic |
| Hex-Cem | | acid (6.0% Manganese) |
| 7% AOC | OMG | aluminum organic complex |
| Bacote 20 | MEI | Ammonim Zirconium Carbonate |
| Boron | Aldrich | |
| trifluoride | | |
| ethylamine | | |
| Calcium | Aldrich | 12.3% calcium |
| (2-ethylhexanoate) | | |
| Calcium Hex-Cem | OMG | 5% calcium |
| Catalyst 320 | OMG | 28% bismuth |
| Cobalt | OMG | 5% cobalt metal |
| Hydro-Cure II | | |
| Dabco 120 | Air Products | 17.5% Tin |
| Dibutyl Tin | Mackenzie | 24.1% Tin |
| acetylacetonate | Chemical | |
| E101 | Degussa | 5% palladium |
| Hex-Cem LED | OMG | 19% Calcium and Zr and rare |
| | | earth <1% |
| K-Kat 5218 | King | Aluminum Chelate |
| | | (4% Aluminum) |
| K-Kat XC 6203 | King | Bismuth carboxylate |
| KR 55 | Kenrich | Titanate coupling agent |
| Manganese | Aldrich | 21.7% Mn II |
| acetylacetonate | | |
| Manganese | OMG | 9% manganese |
| Hydro-Cure | | |
| Manolox WB-1B | Rhodia | 7.1% zirconium |
| Metacure T-1 | Air Products | dibutyl tin diacetate |
| Metacure T-12 | Air Products | dibutyl tin dilaurate |
| Nacure XC 8212 | King | Zinc sulfonate |
| Neo-Cem 250 | OMG | neodymium salt of ethyl- |
| | | hexanoic acid in mineral |
| | | spirits (12% neodynium) |
| NZ 97 | Kenrich | Zirconim IV neoalkanolato, |
| | | tri (3-amino) pheolato-O |
| Potassium Hex-Cem | OMG | Potassium salf of 2-ethyl- |
| | | hexanoic acid |
| | | (15.05% Potassium) |
| Silane A-187 | Witco | Glycidoxypropyltrimethoxy- |
| | Corporation | silane |
| Sodium Persulfate | Aldrich | |
| Titanium | Aldrich | Titanium tetraisobutoxide |
| tetraisobutixide | | |
| Viscomaster 2100 | Chattem | Aluminum Acylate |
| | | (5.2% Aluminum) |
| Viscomaster 2300 | Chattem | Aluminum Alkoxide |
| | | (4.46% Aluminum) |
| Zirconium | OMG | 12% zirconium |
| Hydro-Cem | | |

In a preferred embodiment, the invention comprises 0.1 weight percent to 5 weight percent of the reaction moderator based on total weight of the coating composition; however, the concentration of the reaction moderator varies according to the needs of the particular application for the coating. In a preferred embodiment, at least one or more of the following reaction moderators were found to be most effective at improving coating performance: Desmorapid PP, Ammonium Acetate, Metacure T-1, Metacure T-12, Hexcem LFD, Potassium Hexcem, Neocem 250, Lithium Tencem, Manalox WB-1B, 5% Calcium Hydrocem, and Bacote 20.

### Polymerization

The binders, and optionally dispersants and thickeners of the present invention are to typically in colloidal form, i.e., aqueous dispersions, or in solution and can be prepared by emulsion polymerization in the presence of a chain transfer agent and an initiator. Specific details concerning procedures and conditions for emulsion polymerization are known to those skilled in the art. Typically, however, the polymerization is carried out in an aqueous medium at a temperature of from about 35 to 90° C. The pressure is not critical and is dependent upon the nature of the monomers employed as can be determined by one skilled in the art.

A chain transfer agent is preferably present during the polymerization reaction at a concentration of from about 0.01 to 5 weight percent, preferably from about 0.1 to 2 weight percent based on the total monomer content. Both water-insoluble and water-soluble chain transfer agents can be employed. Illustrative of substantially water-soluble chain transfer agents are alkyl and aryl mercaptans such as butyl mercaptan, mercaptoacetic acid, mercaptoethanol, 3-mercaptol-1,2-propanediol and 2-methyl-2-propanethiol. Illustrative of the substantially water-insoluble chain transfer agents include, for example, t-dodecyl mercaptan, phenyl mercaptan, pentaerythritol tetramercaptopropionate, octyldecyl mercaptan, tetradecyl mercaptan and 2-ethylhexyl-3-mercaptopropionate.

In carrying out the emulsion polymerization, an initiator (also referred to in the art as a catalyst) is preferably used at a concentration sufficient to catalyze the polymerization reaction. This will typically vary from about 0.01 to 3 weight percent based on the weight of monomers charged. However, the concentration of initiator is preferably from about 0.05 to 2 weight percent and, most preferably, from about 0.1 to 1 weight percent of the monomers charged. The particular concentration used in any instance will depend upon the specific monomer mixture undergoing reaction and the specific initiator employed, which details are known to those skilled in the art. Illustrative of suitable initiators include hydrogen peroxide, peracetic acid, t-butyl hydroperoxide, di-t-butyl hydroperoxide, dibenzoyl peroxide, benzoyl hydroperoxide, 2,4-dichlorobenzoyl peroxide, 2,5-dimethyl-2,5-bis(hydroperoxy) hexane, perbenzoic acid, t-butyl peroxypivalate, t-butyl peracetate, dilauroyl peroxide, dicapryloyl peroxide, distearoyl peroxide, dibenzoyl peroxide, diisopropyl peroxydicarbonate, didecyl peroxydicarbonate, dicicosyl peroxydicarbonate, di-t-butyl perbenzoate, 2,2′-azobis-2,4-dimethylvaleronitrile, ammonium persulfate, potassium persulfate, sodium persulfate, sodium perphosphate, azobisisobutyronitrile, as well as any of the other known initiators. Also useful are the redox catalyst systems such as sodium persulfate-sodium formaldehyde sulfoxylate, cumene hydroperoxide-sodium metabisulfite, hydrogen peroxide-ascorbic acid, and other known redox systems. Moreover, as known by those skilled in the art, traces of metal ions can be added as activators to improve the rate of polymerization, if desired.

The particular surfactant useful for conducting the polymerization reaction is not critical to the present invention. Typical surfactants include anionic surfactants such as sodium lauryl sulfate, sodium tridecylether sulfate, diester sulfosuccinates and sodium salts of alkyl aryl polyether sulfonates; and nonionic surfactants such as alkyl aryl polyether alcohols and ethylene oxide condensates of propylene oxide, propylene glycol adducts.

### Preparation of Latex Compositions

Preparation of latex compositions is well known in the paint and coatings art. Any of the well known free-radical emulsion polymerization techniques used to formulate latex polymers can be used in the present invention. Such procedures include, for example, single feed, core-shell, and inverted core-shell procedures which produce homogeneous or structures particles. The reaction products of the polymerizations comprising the binders, and optional dispersants or thickeners of the present invention typically have a solids, i.e., polymer, content of from about 15 to 65 weight percent, preferably from about 20 to 65 weight percent and more preferably from about 25 to 60 weight percent based on the weight of the latex and water.

Furthermore, the coatings used in the present invention may be blended with various kinds of additives which are generally blended with paint. Examples of such additives include pigments, defoamers, surfactants, etc.

### EXAMPLES

The following examples are provided for illustrative purposes and are not intended to limit the scope of the claims which follow.

### Example A

### Preparation of a Macromonomer with Small Hydrophobe

A one-liter glass reactor is provided. The reactor is fitted with a thermometer, heating mantle, thermo-regulator, stirrer, nitrogen sparge, and condenser including a Dean-Stark trap. The reactor is charged with 930 grams of a 40 mole ethoxylate of nonyl phenol, i.e., a small hydrophobe. The reactor contents are heated, with nitrogen sparging, to 110° C. and held for two hours while trace moisture is removed and collected in the Dean-Stark Trap (typically less than 1 g). The reactor contents are then cooled to 80° C., the Dean Stark trap is replaced with a condenser, and the nitrogen sparge is switched to an air sparge for 15 minutes. With continued air sparging, 0.02 g methoxy-hydroquinone inhibitor, 0.50 g dibutyl tin dilaurate catalyst, and 99.7 g of alpha, alpha-dimethyl-m-isopropenyl benzyl isocyanate (m-TMI, a product of CYTEC, Stamford, CT) are charged in order to the reactor. After a rapid initial exotherm, which increases the reaction temperature about 8° C., the contents are maintained at 80° C. for an additional two hours. The product is then cooled to room temperature. The final product is a white wax in appearance with residual isocyanate content of 0.5% and with 98% of the original ethylenic unsaturation retained (referred to hereinafter as “Macromonomer M1”).

### Example B

### Preparation of Macromonomer with Large Hydrophobe

A macromonomer is prepared substantially in accordance with Example A, except that a 20 mole ethoxylate of bis-nonylphenoxy ethanol (large hydrophobe) is used in place of the nonylphenol (small hydrophobe) and the amounts of the reactants used are adjusted to maintain a molar ratio of 1:1.

### Example C

### Latex Binder Preparation

A monomer mixture is prepared by charging 615 grams of VeoVa 10 (a vinyl versatate ester having 10 carbon atoms in the acid portion, commercially available from Shell Chemical), 368 grams of methacrylate (MMA), 9.8 grams diacetone acrylamide (DAAM), 11 grams of methacrylic acid (MAA), 40 grams of Rhodafac 610 (a nonylphenol ethoxylated phosphate ester surfactant available from Rhodia) and 365 grams of water to a 2-liter monomer feed cylinder. A two liter jacketed resin flask equipped with a four-bladed stainless steel mechanical stirrer, Claissen connecting tube, Friedrichs water condenser, nitrogen sparge and bubble trap, thermometer, and monomer addition inlets is used as the reactor. To the reactor is charged 560 grams of water. An initial oxidizer solution, prepared by dissolving 4 grams of ammonium persulfate in 20 grams of water, is prepared in a separate container. Under nitrogen purge, the reactor is heated to 80° C. by circulating temperature controlled water through the reactor jacket. After the temperature of the reactor charge reaches 80° C., the initial oxidizer solution was added to the reactor. Two minutes later, the monomer feed is conveyed to the reaction vessel over a 3 hour period by FMI pumps using ⅛″ Teflon tubing with continuous stirring while the reaction temperature is held between 79° and 81° C. The reaction is allowed to proceed at 80° C. for an additional hour after completion of the monomer feed. To the product is added 15% ammonium hydroxide solution to a pH of 9. To the cooled product is added 0.75 molar amount of a 10% solution of adipic dihydrazide.

### Example D

### Preparation of Crosslinkable Thickener

A monomer mixture (300 grams) is prepared by charging ethyl acrylate, methacrylic acid, diacetone acrylamide, macromonomer from Example A, 13 grams of a 75% solution of Aerosol OT surfactant (American Cyanamid) and 3 grams of distilled deionized water to a bottle, and dispersing the contents with vigorous shaking. The ethyl acrylate, methacrylic acid, diacetone acrylamide, and dispersant are added in the following amounts:

| | | |
|---|---|---|
| ethyl acrylate | 25.0 | wt % |
| methacrylic acid | 40.0 | wt % |
| diacetone acrylamide | 5.0 | wt % |
| dispersant | 30.0 | wt % |

A catalyst feed mixture comprised of 0.53 grams of sodium persulfate and 52.47 grams of water is prepared in another container. To a 2 liter resin flask immersed in a thermostated water bath and equipped with a 4-bladed stainless steel mechanical stirrer, Claissen connecting tube, water condenser, nitrogen sparge and bubble trap, thermometer and monomer and catalyst addition inlets, 1.20 grams of the sodium salt of vinyl sulfonic acid and 658.5 grams of water are charged. The monomer mixture is charged to a 1-liter graduated monomer feed cylinder, and the catalyst solution is charged to a 125 milliliter graduated catalyst feed cylinder. Under nitrogen purge, the reactor is heated to 70° C., whereupon 33 milliliters of the monomer mixture and 3 milliliters of the catalyst feed mixture are charged to the reaction vessel. The reaction vessel is subsequently heated to 80° C. After allowing the monomers to react for 20 minutes to form a seed product, the monomer and catalyst feed mixtures are conveyed to the reaction vessel by FMI pumps via 1/8 inch teflon tubing at a rate of 1.94 and 0.27 milliters/minute, respectively, under continuous stirring at a reaction temperature held between 76° and 82° C. The reaction is allowed to proceed for another hour, after which the product is cooled and filtered with a 200 mesh nylon cloth. The coagulum is collected from the reaction vessel and filter cloth. The product is a low viscosity latex of solids content of about 40% and pH of about 2.5.

### Example E

### Preparation of Crosslinkable Dispersant

A monomer mixture (300 grams) is prepared by charging ethyl acrylate, methacrylic acid, diacetone acrylamide, macromonomer from Example B, 13 grams of a 75% solution of Aerosol OT surfactant (American Cyanamid) and 3 grams of distilled deionized water to a bottle, and dispersing the contents with vigorous shaking. The ethyl acrylate, methacrylic acid, diacetone acrylamide, macromonomer from Example B are added in the following amounts:

| | | |
|---|---|---|
| ethyl acrylate | 22.5 | wt % |
| Methacrylic acid | 17.5 | wt % |
| Diacetone acrylamide | 20.0 | wt % |
| Macromonomer (Ex. B) | 40.0 | wt % |

A catalyst feed mixture comprised of 0.53 grams of sodium persulfate and 52.47 grams of water is prepared in another container. To a 2 liter resin flask immersed in a thermostated water bath and equipped with a 4-beaded stainless steel mechanical stirrer, Claissen connecting tube, water condenser, nitrogen sparge and bubble trap, thermometer and monomer and catalyst addition inlets, 1.20 grams of the sodium salt of vinyl sulfonic acid and 658.5 grams of water are charged. The monomer mixture is charged to a 1-liter graduated monomer feed cylinder, and the catalyst solution is charged to a 125 milliliter graduated catalyst feed cylinder. Under nitrogen purge, the reactor is heated to 70° C., whereupon 33 milliliters of the monomer mixture and 3 milliliters of the catalyst feed mixture are charged to the reaction vessel. The reaction vessel was subsequently heated to 80° C. After allowing the monomers to react for 20 minutes to form a seed product, the monomer and catalyst feed mixtures are conveyed to the reaction vessel by FMI pumps via ⅛ inch teflon tubing at a rate of 1.94 and 0.27 milliters/minute, respectively, under continuous stirring at a reaction temperature held between 76° and 82° C. The reaction is allowed to proceed for another hour, after which the product is cooled and filtered with a 200 mesh nylon cloth. The coagulum is collected from the reaction vessel and filter cloth. The product is a low viscosity latex of solids content of about 25%. The product is subsequently neutralized to a pH of about 9.0.

The binders, thickeners and dispersants described above were used in the formulation of paints as described below. The paint formulations may, in addition to the polymers described herein, contain conventional additives, such as pigments, fillers, wetting agents, coalescents, biocides and anti-foaming agents and the like.

### Example F

### Preparation of Latex Paint

A non-pigmented latex grind is prepared by adding the following ingredients in sequence: 39.51 grams of water, 5.92 grams of a 28% aqueous ammonia solution and 2.55 grams of the dispersant to a HSD-type grinding apparatus with low agitation. The mixture is ground for approximately 30 minutes, or until a fineness of grind of 8 Hegman is obtained. The agitation is reduced and 200.8 grams of titanium dioxide (DuPont R-706) and 0.89 grams of BYK 024 (Byk-Gardner) defoamer is added.

A thickener premix is prepared by adding 10.32 grams of water to a mix tank and under agitation, adding 0.25 grams of Example D thickener and 0.25 grams of 28% aqueous ammonia solution to the tank.

The paint is prepared by adding 261.29 grams of Example C binder resin to the grind mixture under agitation. After this mixture is agitated for about 30 minutes, the following ingredients are added in order: 25.6 grams of propylene glycol, 5.81 grams of DPM (Dipropylene Glycol Methyl Ether from Dow Chemical), 11.62 grams of Arcosolve DPNB (dipropylene glycol n-butyl ether from Dow Chemical), 21.29 grams of Exxate 600 (High molecular weight Alkyl Acetates from Exxon Chemical). The thickener premix is then added under agitation. Flash X-150, flash rust inhibitor (Halox) in an amount of 0.05 grams is then added, followed by 1.48 grams of Byk 307 (wetting agent from BYK-Chemie). The clear solution is mixed until it is homogeneous. Reaction moderators are post-added with agitation, at about 0.5% by weight of the total resin weight.

### Example G

### Commercially Available Latex

A commercially available latex coating, Luhydran A848S, a product from BASF Corporation, was used to determine the feasibility of this invention with commercially available formulations. The grind comprises the following: 117.8 grams water, 9.6 grams 10% TKPP thickener solution, 3.9 grams Pigment Disperser NL, 1.23 grams Proxel GXL, 5.09 grams Foamaster, 32.64 grams Dowanol DPnB coalescent; Letdown: 239.53 grams Kronos 2310, Thindown: 584.17 grams Luhydran A848S, 2.05 grams Foamaster S; thickener premix: 10.12 grams Collacral PU 85 thickener and 12.88 grams of Ektasolve EB (butyl carbitol).

Comparative samples of the coatings in Examples F and G were blended with approximately 2% by weight of at least one reaction moderator at various amounts and combinations. The mixtures were drawn down to 1.5 mils dry film on a Bonderite 1000 substrate and compared with the control having no added reaction moderator for evaluation of chemical resistance, gloss, corrosion resistance, and humidity resistance.

The attached tables show results of chemical resistance, salt fog, and humidity testings of latex samples of Examples F and G using various levels of reaction moderators.

CHEMICAL RESISTANCE

| SAMPLE | Copper 30 | D.W.O | TOLUENE | 10% H2SO4 | IPA | 10% NaOH | MEK | F409 | TOTAL |
|---|---|---|---|---|---|---|---|---|---|
| Ex. F + 0.78 g | 5 | 3.5 | 4 | 1 | 3 | 3 | 4 | 4.5 | 28 |
| Desmorapid PP | | | | | | | | | |
| Ex. F + 2.3 g | 5 | 3 | 5 | 2 | 3 | 3 | 5 | 5 | 31 |
| Hexcem LFD | | | | | | | | | |
| Ex. F. + 1.3 g | 5 | 3 | 4 | 1.5 | 3 | 2 | 4 | 4 | 26.5 |
| Calcium/Malic | | | | | | | | | |
| Acid | | | | | | | | | |
| Ex. F + 1.3 g | 4 | 3 | 4 | 1 | 3 | 2 | 4 | 2 | 23 |
| Manalox WB-1B | | | | | | | | | |
| Ex. F (no | 4 | 3 | 4 | 1 | 3 | 2 | 2.5 | 2.5 | 22 |
| catalyst) | | | | | | | | | |

HUMIDITY (200 HOURS)

| | Surface Appearance After 200 hours Exposure | | | | | |
|---|---|---|---|---|---|---|
| | 60° Gloss | | | Rust | Blister Rating | |
| Sample | Initial | 200 Hr. | % Loss | Rating | Size | Density |
| Ex. F + 078 g | 69.1 | 55.7 | −19.39% | 8 | 8 | 3 |
| Desmorapid | | | | | | |
| PP | | | | | | |
| Ex. F + 2.3 g | 51.0 | 29.5 | −42.16% | 6 | 8 | 2 |
| Hexcem LFD | | | | | | |
| Ex. F + 1.3 g | 65.5 | 50.6 | −22.75% | 6 | 8 | 3 |
| Calcium/Malic | | | | | | |
| Acid | | | | | | |
| Ex. F + 1.3 g | 63.8 | 43.2 | −32.29% | 7 | 8 | 4 |
| Manalox WB- | | | | | | |
| 1B | | | | | | |
| Ex. F (no | 66.7 | 40.4 | −39.43% | 3 | 8 | 2 |
| catalyst) | | | | | | |

SALT SPRAY (175 HOURS)
SURFACE APPEARANCE - 175 HOURS EXPOSURE

| Sample | Blister Size | Face Rust |
|---|---|---|
| Example F (no catalyst) | 6 | 2 |
| Example F + 2% Hexcem | 8 | 9 |
| Example F + 0.5% 5% Calcium Hydrocem | 8 | 8 |
| Example F + 0.5% KC 5218 | 6 | 9 |
| Example F + 1% Desmorapid PP + | 4 | 9 |
| 1% Calcium Hydrocem | | |
| Example F + 1% Ammonium Acetate + | 8 | 5 |
| 1% T-12 | | |
| Example F + 1% Ammonium Acetate + | 6 | 8 |
| 1% Hexcem LFD | | |
| Example F + 1% Ammonium Acetate + | 6 | 6 |
| 1% Neocem 250 | | |
| Example F + 1% Ammonium Acetate + | 6 | 8 |
| 1% Calcium Hydrocem | | |

AMBIENT CURE
(30 minutes, 140° F., 7 day air dry)

| Property | Test Method | | Measurement | |
|---|---|---|---|---|
| Chemical Resistance | ASTM D3912-80 24 hr. | | Rating | |
| | exposure | | 1. | Total Failure |
| | Key Chemicals: | | 2. | severe Failure |
| | 1. | Formula 409 | 3. | slight failure |
| | 2. | isopropanol | 4. | minimal failure |
| | 3. | MEK | 5. | no effect |
| | 4. | Toluene | | |
| | 5. | 10% NaOH | | |
| | 6. | 10% sulfuric acid | | |
| | 7. | Deep Woods Off | | |
| | | Spray | | |
| | 8. | Coppertone 30 | | |

| Pencil Hardness | ASTM D3363 | Use film breakthrough | |
|---|---|---|---|
| Salt Spray | ASTM B117 | 200 | hours |
| Humidity Resistance | ASTM D2274 | 200 | hours |
| Rust Rating | ASTM D610 | 175 | hours |
| Blister Size | ASTM D714 | 175 | hours |

Key for Tables:
DWO = Deep Woods Off Spray
Coppertone = Coppertone 30
IPA = isopropyl alcohol
MEK = methyl ethyl ketone

While this invention has been described by a specific number of embodiments, other variations and modifications may be made without departing from the spirit and scope of the invention as set forth in the appended claims.

The entire disclosure of all applications, patents and publications cited herein are hereby incorporated by reference.

The invention claimed is:

1. A waterborne coating composition for a cured film having improved film properties comprising:
(a) a binder polymer comprising one or more copolymerizable monoethylenically unsaturated monomers, wherein at least one of said monoethylenically unsaturated monomers contains at least one reactive keto group; and
(b) at least one monohydrazide or dihydrazide or polyhydrazide compound; and
(c) at least one reaction moderator capable of moderating or retarding crosslinking before film formation.

2. The coating composition of claim 1 wherein said monoethylenically unsaturated monomer comprises at least one keto-containing monomer selected from the group consisting of acrolein, methacrolein, diacetone acrylamide, diacetone methacrylamide and vinylaceto acetate, and acetoacetoxy ethylmethacrylate.

3. The coating composition of claim 1 wherein the composition further comprises a second polymer comprising a monoethylenically unsaturated monomer.

4. The coating composition of claim 3 wherein said second polymer is a dispersant polymer.

5. The coating composition of claim 3 wherein said second polymer is a thickener polymer.

6. The coating composition of claim 1 further comprising a dispersant polymer and a thickener polymer.

7. The coating composition of claim 4 wherein the dispersant comprises a macromonomer comprising a hydrophobic portion and an alkoxylated portion which is polymerizable with the other monomers.

8. The coating composition of claim 5 wherein the thickener comprises a macromonomer comprising a hydrophobic portion and an alkoxylated portion which is polymerizable with the other monomers.

9. The coating composition of claim 1 wherein the binder polymer comprises:
(a) 50-85% by weight of an ethylenically unsaturated monomer;
(b) 0.1-50% by weight of diacetone acrylamide; and
(c) 0.5%-5% by weight of methacrylic acid, based on the total weight of the binder polymer.

10. The coating composition of claim 1 wherein the reaction moderator is an amine catalyst.

11. The coating composition of claim 1 wherein the reaction moderator is a metal catalyst.

12. The coating composition of claim 1 wherein the reaction moderator catalyzes a post-film formation crosslinking reaction.

13. The coating composition of claim 1 wherein the at least one monohydrazide, dihydrazide or polyhydrazide compound is selected from the group consisting of maleic dihydrazide, fumaric dihydrazide, itaconic dihydrazide, phthalic dihydrazide, isophthalic dihydrazide, terephthalic dihydrazide, oxalic dihydrazide, adipic dihydrazide, sebacic dihydrazide, and citric trihydrazide.

14. The coating composition of claim 13 wherein at least one monohydrazide, dihydrazide or polyhydrazide compound is present in an amount of from 0.1 to 3 molar equivalent based on the keto group content on the binder polymer.

15. The coating composition of claim 1 wherein the binder polymer is present in an amount from 20 weight percent to about 90 weight percent, the at least one monohydrazide or dihydrazide or polyhydrazide compound is present in an amount between about 0.1 weight percent to about 3.0 weight percent, and the reaction moderator is present in an amount between about 0.1 weight percent to about 4.0 weight percent, based on the total weight of the coating composition.

16. A waterborne coating composition comprising:
(a) a binder polymer comprising one or more copolymerizable monoethylenically unsaturated monomers, wherein at least one of said monoethylenically unsaturated monomers contains at least one keto group; and
(b) at least one monohydrazide or dihydrazide or polyhydrazide compound; and
(c) a second polymer comprising the reaction product of:
(i) an unsaturated carboxylic acid monomer,
(ii) a monoethylenically unsaturated monomer different from the carboxylic acid monomer,
(iii) a monoethylenically unsaturated monomer containing at least one keto group,
(d) a reaction moderator capable of moderating or retarding crosslinking before film formation.

17. The coating composition of claim 16 wherein said monoethylenically unsaturated monomer comprises at least one keto-containing monomer selected from the group consisting of acrolein, methacrolein, diacetone acrylamide, diacetone methacrylamide and vinylaceto acetate.

18. The coating composition of claim 16 wherein at least one monohydrazide, dihydrazide or polyhydrazide compound is present in an amount of from 0.1 to 3 molar equivalent based on the keto group content on the binder polymer.

19. The coating composition of claim 16 wherein the binder polymer comprises:
(a) 50-85% by weight of an ethylenically unsaturated monomer;
(b) 0.1-50% by weight of diacetone acrylamide; and
(c) 0.5%-5% by weight of methacrylic acid, based on the total weight of the binder polymer.

20. The coating composition of claim 16 further comprising a second polymer comprising the reaction product of:
(i) an unsaturated carboxylic acid monomer,
(ii) a monoethylenically unsaturated monomer different from the carboxylic acid monomer, and
(iii) a monoethylenically unsaturated monomer containing at least one keto group.

21. The coating composition of claim 16 wherein the reaction moderator is an amine catalyst.

22. The coating composition of claim 16 wherein the reaction moderator is a metal catalyst.

23. The coating composition of claim 16 wherein the reaction moderator can catalyze a post-film formation crosslinking reaction.

24. The coating composition of claim 16 wherein the at least one monohydrazide, dihydrazide or polydrazide compound is selected from the group consisting of maleic diihydrazide, fumaric dihydrazide, itaconic dihydrazide, phthalic dihydrazide, isophthalic dihydrazide, terephthalic dihydrazide, oxalic dihydrazide, adipic dihydrazide, sebacic dihydrazide, and citric trihydrazide.

25. The coating composition of claim 24 wherein at least one monohydrazide, dihydrazide or polyhydrazide compound is present in an amount of from 0.1 to 3 molar equivalent based on the keto group content on the binder polymer.

26. The coating composition of claim 16 wherein the binder polymer is present in an amount from 20 weight percent to about 90 weight percent, the at least one monohydrazide or dihydrazide or polyhydrazide compound is present in an amount between about 0.1 weight percent to about 3.0 weight percent, the second polymer is present in an amount between about 0.1 weight percent to about 0.5 weight percent, and the reaction moderator is present in an amount between about 0.1 weight percent to about 4.0 weight percent, based on the total weight of the coating composition.

27. A method of producing a waterborne coating composition for a cured film having increased crosslinking and uniform film formation, comprising:
(a) providing a binder polymer comprising one or more copolymerizable monoethylenically unsaturated monomers, wherein at least one of said monoethylenically unsaturated monomers contains at least one keto grouup; and
(b) reacting with at least one monohydrazide or dihydrazide or polyhydrazide compound with at least an amount from 0.5 to 1.0 mole equivalent based on the keto group content contained in the binder polymer; and
(c) adding at least one reaction moderator capable of moderating or retarding crosslinking before film formation.

28. The method of claim 27 wherein said monoethylenically unsaturated monomer comprises at least one keto-containing monomer selected from the group consisting of acrolein, methacrolein, diacetone acrylamide, diacetone methacrylamide and vinylaceto acetate.

29. The method of claim 27 further comprising adding a dispersant polymer.

30. The method of claim 27 further comprising adding a thickener polymer.

31. The method of claim 29 wherein the dispersant comprises a macromonomer comprising a hydrophobic portion and an alkoxylated portion which is polymerizable with the other monomers.

32. The method of claim 29 wherein the thickener comprises a macromonomer comprising a hydrophobic portion and an alkoxylated portion which is polymerizable with the other monomers.

33. The method of claim 27 wherein the binder polymer comprises:
(a) 50-85% by weight of an ethylenically unsaturated monomer;
(b) 0.1-50% by weight of diacetone acrylamide; and
(c) 0.5%-5% by weight of methacrylic acid, based on the total weight of the binder polymer.

34. The method of claim 27 wherein the at least one keto containing monomer comprises diacetone acrylamide.

35. The method of claim 27 wherein the reaction moderator is an amine catalyst.

36. The method of claim 27 wherein the reaction moderator is a metal catalyst.

37. The method of claim 27 wherein the reaction moderator can catalyze a post-cure crosslinking reaction.

38. The method of claim 27 wherein the at least one monohydrazide or dihydrazide or polyhydrazide compound is selected from the group consisting of maleic dihydrazide, fumaric dihydrazide, itaconic dihydrazide, phthalic dihydrazide, isophthalic dihydrazide, terephthalic dihydrazide, oxalic dihydrazide, adipic dihydrazide, sebacic dihydrazide, and citric trihydrazide.

39. The method of claim 38 wherein at least one monohydrazide, dihydrazide or polyhydrazide compound is present in an amount of from 0.1 to 3 molar equivalent based on the keto group content on the binder polymer.

40. A process for forming a highly crosslinked cured film having uniform film formation on a surface, comprising:
(a) forming a waterborne coating composition comprising:
(1) providing a binder polymer comprising one or more copolymerizable monoethylenically unsaturated monomers, wherein at least one of said monoethylenically unsaturated monomers contains at least one keto group; and
(2) reacting said binder polymer with at least one monohydrazide, dihydrazide or polyhydrazide compound; and
(3) adding at least one reaction moderator capable of moderating or retarding crosslinking before film formation; and
(b) coating said surface with said coating composition; and
(c) permitting said coating composition to crosslink to form a highly crosslinked uniform cured film.

41. The process of claim 40 wherein said monoethylenically unsaturated monomer comprises at least one keto-containing monomer selected from the group consisting of acrolein, methacrolein, diacetone acrylamide, diacetone methacrylamide and vinylaceto acetate.

42. The process of claim 40 wherein said second polymer is a dispersant polymer.

43. The process of claim 40 wherein said second polymer is a thickener polymer.

44. The process of claim 42 wherein the dispersant polymer comprises a macromonomer including a hydrophobic portion and an alkoxylated portion that is polymerizable with the monoethylenically unsaturated monomer.

45. The process of claim 43 wherein the thickener polymer comprises a macromonomer including a hydrophobic portion and an alkoxylated portion that is polymerizable with the monoethylenically unsaturated monomer.

46. The process of claim 40 wherein the binder polymer comprises:
(a) 0-60% by weight of a fatty acid vinyl ester;
(b) 0-60% by weight of a styrene monomer;
(c) 0-50% by weight of an acrylate or methylmethacrylate;
(d) 0.5-50% by weight of diacetone acrylamide; and
(d) 0.5%-5% by weight of methacrylic acid, based on the total weight of the binder polymer.

47. The process of claim 40 wherein the at least one keto containing monomer comprises diacetone acrylamide.

48. The process of claim 40 wherein the reaction moderator is an amine catalyst.

49. The process of claim 40 wherein the reaction moderator is a metal catalyst.

50. The process of claim 40 wherein the reaction moderator can catalyze a post film formation crosslinking reaction.

51. The process of claim 40 wherein the at least one monohydrazide or dihydrazide or polyhydrazide compound is selected from the group consisting of maleic diihydrazide, fumaric dihydrazide, itaconic dihydrazide, phthalic dihydrazide, isophthalic dihydrazide, terephthalic dihydrazide, oxalic dihydrazide, adipic dihydrazide, sebacic dihydrazide and citric trihydrazide.

52. The process of claim 40 wherein at least one monohydrazide, dihydrazide or polyhydrazide compound is present in an amount of from 0.1 to 3 molar equivalent based on the keto group content on the binder polymer.
